(19) United States
(12) Patent Application Publication
(10) Pub. No.: US 2025/0115798 A1
(43) Pub. Date: Apr. 10, 2025

(54) Phase-change temperature-reducing polyurethane composite material, and preparation method and application thereof

(71) Applicant: Thermalysis New Material Technology Co., Ltd., Shenzhen (CN)

(72) Inventor: Tianxu Huang, Shenzhen (CN)

(21) Appl. No.: 18/817,236

(22) Filed: Aug. 28, 2024

(30) Foreign Application Priority Data
Sep. 4, 2023 (CN) 202311138905.0

(51) Int. Cl. C09K 5/06; C08J 3/22; C08J 9/00; C08K 3/34; C08K 7/00; C08L 75/08

(52) U.S. Cl. CPC C09K 5/066; C08J 3/226; C08J 9/0009; C08J 9/0066; C08K 3/346; C08K 7/00; C08L 75/08; C08J 2201/022; C08J 2375/08; C08J 2491/06; C08L 2203/14; C08L 2205/03; C08L 2310/00; C08L 2314/00

(57) ABSTRACT

The present invention pertains to the technical field of phase-change temperature-reducing materials, and in particular, relates to a phase-change temperature-reducing polyurethane composite material, and a preparation method and application thereof, comprising the following parts by mass of raw materials: 50-80 parts of polyurethane material A+polyurethane material B, 1-3 parts of flake graphite powder with a particle size of 850-1200 meshes, 0.8-1.8 parts of vermicular graphite with a particle size of 10-40 meshes, 10-30 parts of phase-change paraffin, 1-3 parts of activated carbon, 0.5-2 parts of catalyst, and 0.2-1 parts of co-catalyst. The polyurethane composite material made in the present invention is rapid in phase-change temperature reduction, high in heat absorption and dispersion, and free of problems of phase-change paraffin leakage, crystallization, and frosting on the surface thereof. At the same time, it also has softness and high elasticity, and can be widely applied to objects in contact with human bodies. A temperature difference is formed by reducing the temperature of the surface in contact with skin, which can bring a comfortable sense of coolness and a temperature-reducing effect to consumers.

### TECHNICAL FIELD

The present invention pertains to the technical field of phase-change temperature-reducing materials, and particularly relates to a phase-change temperature-reducing polyurethane composite material, and a preparation method and application thereof.

### BACKGROUND

PU, short for polyurethane, is divided into polyester type and polyether type, and can be made into a series of products such as polyurethane plastics, polyurethane fibers, polyurethane rubbers, and elastomers. Nowadays, the application of polyurethane materials has become more and more extensive. For example, used in the field of construction, polyurethane materials can perform functions of thermal insulation and heat preservation; used in the preparation of sports products such as insoles, soles, protectors, and mats, they can enhance the elasticity of the sports products, so that the sports products have a certain degree of softness and are light to wear.

However, made from traditional polyurethane high molecular materials, products such as insoles and backpacks do not have functions of heat dissipation and temperature reduction. For example, when a traveler or pedestrian carries a backpack on a hot summer day, in the high-temperature environment, the breathable mesh or heat-dissipating structure on the back cannot effectively dissipate the heat released from the back; multiple layers of polyurethane sponge fillers are usually arranged in a protective bag for a laptop computer and stacked up to form a super-thick lining to protect the computer from collision; since the lining does not have heat dissipation or breathability, when it is the protective bag for the laptop computer that is pressed against the back, the heat circulation and accumulation are further exacerbated on the back, and the temperature is increased on the human back, which makes the back slippery, sticky, and uncomfortable. Therefore, how to prepare a new polyurethane material with functions of heat dissipation and temperature reduction is a technical problem that needs to be solved urgently.

At the same time, the existing polyurethane material production process still suffers from a long reaction time, and takes a reaction time of 40 min or more at least. For example, the patent for invention with Publication No. CN115304738B discloses a polyurethane composition for traditional Chinese medicine insoles and a preparation method thereof, comprising the following steps: (1) preparation of Component A: mixing traditional Chinese medicine extract liquor of polyether polyol a, polymer polyol, a chain extender, a cell stabilizer, a catalyst, and a foaming agent evenly at 30-40° C., thereby obtaining Component A; (2) preparation of Component B: dehydrating polyether polyol b, adding phosphoric acid, stirring for 20-30 min, adding pure MDI, heating to 80-85° C., holding the temperature for 1.5-2 h, adding carbodiimide-modified MDI, stirring for 20-30 min, thereby obtaining Component B; wherein the phosphoric acid has an additive amount of 0.0015-0.005% of the total mass of Component B; (3) injecting Components A, B into a feed tank of a low-pressure casting machine, and injecting them into a mold according to a corresponding proportion; heating to 40-50° C., opening the mold after 3-4 min, molding, and trimming; standing still for 1-1.5 h, thereby obtaining a polyurethane composition insole. Therefore, how to shorten the reaction time of the polyurethane materials and optimize the production process are of great significance.

### SUMMARY

In light of the above, it is an objective of the present invention to propose a phase-change temperature-reducing polyurethane composite material, and a preparation method and application thereof, on the one hand, to solve the problem of heat dissipation and temperature reduction of polyurethane materials, and on the other hand, to shorten the preparation time of the polyurethane materials and optimize the production process.

To achieve the above objective, the present invention provides a phase-change temperature-reducing polyurethane composite material, comprising parts by mass of raw materials as follows: 50-80 parts of polyurethane material A+polyurethane material B, 1-3 parts of flake graphite powder with a particle size of 850-1200 meshes, 0.8-1.8 parts of vermicular graphite with a particle size of 10-40 meshes, 10-30 parts of phase-change paraffin, 1-3 parts of activated carbon, 0.5-2 parts of catalyst, and 0.2-1 parts of co-catalyst.

Further, the phase-change temperature-reducing polyurethane composite material comprises parts by mass of raw materials as follows: 50-80 parts of polyurethane material A+polyurethane material B, 1-3 parts of flake graphite powder with a particle size of 850-1200 meshes, 0.8-1.8 parts of vermicular graphite with a particle size of 10-40 meshes, 10-30 parts of phase-change paraffin, 1-3 parts of montmorillonite, 1-3 parts of activated carbon, 0.5-2 parts of catalyst, 0.2-1 parts of co-catalyst, 0.2-1 parts of foaming agent, 0.2-1 parts of dispersing agent, and 0.2-1 parts of crosslinking agent.

Further, the polyurethane material A is formed by mixing polyepoxypropane ether glycol with polyepoxypropane ether triol at a mass ratio of 1:(1-3).

Further, the polyurethane material B is one or more of xylylene diisocynate, hexamethylene diisocyanate, and isophorone isocyanate.

Further, the mass ratio of the polyurethane material A to the polyurethane material B is 1:(0.4-0.5).

Further, the catalyst is one or more of triethylenediamine, bis(2, dimethylaminoethyl)ether, and N,N-dimethylcyclohexylamine.

Further, the phase-change paraffin has a melting point of 35° C.; the co-catalyst is hexaaminobenzen; and the foaming agent is water.

Further, the dispersing agent is one or more of polyacrylamide, sodium polyacrylate, and polyoxyethylene ether.

Further, the crosslinking agent is one or more of glycerol, trimethylolpropane, triethanolamine, and pentaerythritol.

The present invention further provides a preparation method of the phase-change temperature-reducing polyurethane composite material, comprising steps as follows:
S1: mixing the vermicular graphite with a particle size of 10-40 meshes, the activated carbon, and the phase-change paraffin evenly at 40° C., then cooling and molding at room temperature of 25° C., thereby obtaining premix I;
S2: mixing and banburying the polyurethane material A, the flake graphite powder with a particle size of 850-1200 meshes, the premix I, and the dispersing agent for 3 min at 50° C., then adding montmorillonite, the catalyst, and the co-catalyst, and mixing and banburying for 3 min, thereby obtaining premix II;
S3: adding the polyurethane material B, the foaming agent, and crosslinking agent to the premix II, then mixing and banburying at 50° C. for 7-10 s, quickly injecting a resultant compound into a mold for foaming, curing, and molding through a nozzle of a filling machine, with a foaming temperature of 45-60° C. and a foaming time of 4-5 min, and then die cutting, thereby obtaining sheets of the polyurethane composite material.

The present invention further provides application of the phase-change temperature-reducing polyurethane composite material in the preparation of shoe insoles, fitness mats, sports protectors, mouse pads, protective covers for cell phones or tablet computers, backpack inner liners, mattresses, seat cushions, floor cushions, and garment fabrics.

The present invention has beneficial effects as follows.

The polyurethane composite material made in the present invention is rapid in phase-change temperature reduction, high in heat absorption and dispersion, and free of problems of phase-change paraffin leakage, crystallization, and frosting on the surface thereof. At the same time, it also has softness and high elasticity, and can be widely applied to objects in contact with human bodies. A temperature difference, formed by reducing the temperature of the surface in contact with skin, can bring a comfortable sense of coolness and a temperature-reducing effect to consumers. Moreover, it has a long-term recycling property that it can absorb heat and reduce temperature many times without loss of performances, which can not only lower the surface temperature within a short period of time, but recover quickly and exert a heat-absorbing temperature-reducing effect again after dissipating heat to the environment.

For the first time, the present invention creatively applies hexaaminobenzene to the synthesis of polyurethane. As a co-catalyst, it promotes a full reaction of the polyurethane material A and the polyurethane material B within a very short period of time, thereby greatly improving the reaction rate. Within about 10 min, the preparation of the polyurethane composite material can be finished, which is of great economic value for the process production of enterprises in practice. At the same time, hexaaminobenzene also helps to enhance the crosslinking density and polymerization degree of the polyurethane composite material, restricts the movement of molecules of the phase-change paraffin, and further improves the resistance of the finished product to paraffin leakage and frosting to a certain extent.

The inventors also found that created by premixing the vermicular graphite with a particle size of 10-40 meshes, the activated carbon, and the phase-change paraffin, a composite-phase structure adsorbing paraffin fluid can significantly inhibit the infiltration and flow of the phase-change paraffin. At the same time, since the composite-phase structure restricts the activity of non-reactive monomer paraffin, it also contributes to a certain extent to the full reaction of the polyurethane material A and the polyurethane material B.

### BRIEF DESCRIPTION OF DRAWINGS

To make clearer the technical solutions in the present invention or in the prior art, the figures that need to be used in the description of the embodiments or the prior art will be briefly introduced below. Obviously, the figures in the following description only relate to the present invention. For persons skilled in the art, other figures can be obtained based on these figures without creative labor.

FIG. 1 is a DSC curve graph of a phase-change temperature-reducing polyurethane composite material made in Example 1, wherein the anasiys of the peak of the curve (up) including area 52.54 J/g, peak 28.8° C., starting point 24.6° C., termination point 33.9° C., width 10.8° C. (10.000%) and height 0.657 mW/mg, and the anasiys of the peak of the curve (down) including area −55.92 J/g, peak 40.1° C., starting point 34.9° C., termination point 42.5° C., width 9.8° C. (10.000%) and height 0.8173 mW/mg.

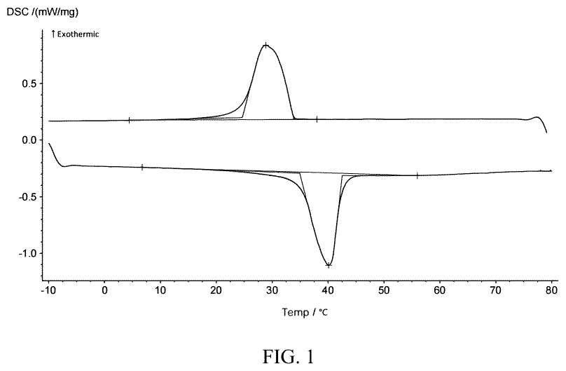

### DESCRIPTION OF EXAMPLES

To make the objectives, technical solutions, and advantages of the present invention clearer, the present invention is described below in further detail in combination with specific examples.

In an example, the present invention provides a phase-change temperature-reducing polyurethane composite material, comprising parts by mass of raw materials as follows: 50-80 parts of polyurethane material A+polyurethane material B, 1-3 parts of flake graphite powder with a particle size of 850-1200 meshes, 0.8-1.8 parts of vermicular graphite with a particle size of 10-40 meshes, 10-30 parts of phase-change paraffin, 1-3 parts of activated carbon, 0.5-2 parts of catalyst, and 0.2-1 parts of co-catalyst.

In this example, a polyurethane substrate is formed by mixing the polyurethane material A with the polyurethane material B and directly expanding and foaming in a chemical reaction, and the phase-change paraffin serves as a phase-change temperature-reducing body and has a heat-absorbing temperature-reducing effect. The flake graphite powder with a particle size of 850-1200 meshes is high in graphite density, and useful for improving the heat-conducting property in cooperation with the vermicular graphite. At the same time, in the course of research and development, the inventors found that a composite material free of leaking and frosting on the surface can be made by premixing the vermicular graphite with a particle size of 10-40 meshes, the activated carbon, and the phase-change paraffin, without using high-cost microencapsulated paraffin, which solves the problems that the phase-change paraffin in the polyurethane material suffers from leakage and frosting on the surface, and greatly reduces the cost of production. The reason for taking them into consideration is that the vermicular graphite and the activated carbon have such a relatively high pore or channel structure for synergetic absorption, accommodation, and storage of paraffin fluid as to create a composite phase that adsorbs the paraffin fluid, thereby inhibiting the penetration and flow of paraffin.

The polyurethane material A, formed by mixing polyepoxypropane ether glycol with polyepoxypropane ether triol at a mass ratio of 1:(1-3), acts as a main reactant in the preparation course of polyurethane, and reacts with the material B to form a polyurethane polymer, which ensures the physical properties of the polyurethane material, such as flexibility, elasticity, and tensile strength.

The polyurethane material B is one or more of xylylene diisocynate, hexamethylene diisocyanate, and isophorone isocyanate, reacts with the polyurethane material A to form a polyurethane polymer, which promotes the curing and hardening courses of the polyurethane material, and affects the properties of the polyurethane material, such as hardness, abrasion resistance, and weather resistance.

The inventors make the polyurethane possess favorable heat-absorbing and heat-conducting properties, structural stability, and leakage prevention by scientifically compounding flake graphite powder with a particle size of 850-1200 meshes with vermicular graphite with a particle size of 10-40 meshes, specifically:
the flake graphite powder has a good heat-conducting property, which can promote the heat-absorbing course of the phase-change paraffin; when the phase-change paraffin absorbs heat, the graphite powder can conduct the heat rapidly, and improve the heat conduction efficiency of the whole composite material, so that the phase-change paraffin can realize the phase change and release the heat faster;
the vermicular graphite, with a high specific surface area and a large number of porous structures, can adsorb and immobilize molecules of the phase-change paraffin, reducing the flow and leakage thereof in the composite material; at the same time, the porous structures of the vermicular graphite can also provide a certain degree of barrier effect, thereby mitigating both the penetration of the phase-change paraffin from the surface of the material to the external environment and the frosting on the surface;
increase in the stability and strength of the material: the flake graphite powder and the vermicular graphite have a good reinforcing effect, which can increase the stability and strength of the polyurethane substrate;
the phase-change paraffin, with a melting point of 35° C., has the following characteristics and functions:
phase-change property: the phase-change paraffin, as a material with solid-liquid phase-change properties, transforms from a solid state to a liquid state within a specific temperature range, absorbs a large amount of heat, and realizes the storage of heat energy, and this phase-change course can be carried out repeatedly, which makes the phase-change paraffin have a reversible capacity of heat storage;
heat absorption and heat release: the phase-change paraffin will undergo phase change when absorbing heat, and the absorbed heat is converted into latent heat and stored in the material; when the ambient temperature drops, the phase-change paraffin will release the stored heat and perform the function of heat preservation; the heat-absorbing and heat-releasing courses of the phase-change paraffin can be carried out stably within temperature control ranges;
temperature regulation: the phase-change paraffin can automatically adjust the release and absorption of heat according to the change of the ambient temperature, so as to realize temperature regulation and control; in the indoor environment, the phase-change paraffin can absorb the excess indoor heat, thereby reducing the room temperature; when the temperature of the outdoor environment decreases, the phase-change paraffin can release the stored heat to provide additional heat energy;
energy conservation and environmental protection: the characteristics of heat storage and temperature regulation of the phase-change paraffin can effectively save energy consumption and reduce energy waste; compared with traditional temperature control devices, the phase-change paraffin has lower energy consumption and higher efficiency; as it can absorb and release heat repeatedly, it has a constant effect of heat absorption and temperature reduction;
the activated carbon plays the following roles in preventing paraffin leakage:
adsorptive action: the activated carbon, with a very high adsorptive property, can adsorb and immobilize paraffin molecules to prevent them from leakage or penetration; the pore structure of the activated carbon provides a large number of adsorptive surfaces, which can adsorb the paraffin molecules and immobilize them on the surfaces thereof, thereby reducing the mobility and volatility thereof;
filling effect: the activated carbon can fill pores or defects of the composite material and seal channels through which paraffin is leaked; by filling the pores, the activated carbon can increase the compactness and evenness of the composite material, thereby reducing the leakage of molecules of the phase-change paraffin;
the catalyst is a tertiary amine catalyst, and is specifically one or more of triethylenediamine, bis(2, dimethylaminoethyl)ether, and N,N-dimethylcyclohexylamine;
the co-catalyst is hexaaminobenzene; in the course of research and development, the inventors accidentally found that by adopting hexaaminobenzene as a co-catalyst and introducing it into the reaction system, the synthetic efficiency of polyurethane can be improved significantly, and the reaction course can be shortened; the reason may be that the intermediate generated in the reaction of hexaaminobenzene and the polyurethane material B may reduce the activation energy of the reaction system, thereby significantly speeding up the reaction of the polyurethane material A and the polyurethane material B.

The phase-change temperature-reducing polyurethane composite material in this example further comprises as follows parts of mass of raw materials: 1-3 parts of montmorillonite, 0.2-1 parts of foaming agent, 0.2-1 parts of dispersing agent, and 0.2-1 parts of crosslinking agent;

Montmorillonite powder can stabilize the phase-change paraffin to a certain extent, and further prevent it from leakage or penetration; there are several mechanisms of stabilizing paraffin with the montmorillonite powder as follows:
pore filling: the montmorillonite powder can fill pores or defects of the polyurethane material and seal channels through which paraffin is leaked; by filling the pores, the montmorillonite powder can increase the compactness and evenness of the polyurethane composite material, thereby improving the closure of the material;
barrier effect: since the montmorillonite powder has a special layer structure, it can block the movement path of molecules of the phase-change paraffin, reduce the possibility of the leakage thereof, and form a physical barrier to prevent the diffusion and flow of molecules of the phase-change paraffin;
adsorptive action: the montmorillonite powder, relatively large in specific surface area and pore structure, can adsorb and wrap molecules of the phase-change paraffin, preventing free flow or leakage thereof; the high specific surface area of the montmorillonite powder provides more contact area, and increases the interaction with the molecules of the phase change paraffin, thereby effectively preventing the leakage and frosting of the phase-change paraffin;
the foaming agent is water;
the dispersing agent is one or more of polyacrylamide, sodium polyacrylate, and polyoxyethylene ether;
the crosslinking agent is one or more of glycerol, trimethylolpropane, triethanolamine, and pentaerythritol.

The preparation method of preparation method of the phase-change temperature-reducing polyurethane composite material, comprising steps as follows:
S1: mixing the vermicular graphite with a particle size of 10-40 meshes, the activated carbon, and the phase-change paraffin evenly at 40° C., then cooling and molding at room temperature of 25° C., thereby obtaining premix I;
the inventors also found that created by premixing the vermicular graphite with a particle size of 10-40 meshes, the activated carbon, and the phase-change paraffin, a composite-phase structure adsorbing paraffin fluid can significantly inhibit the infiltration and flow of the phase-change paraffin. At the same time, since the composite-phase structure restricts the activity of non-reactive monomer paraffin, it also contributes to a certain extent to the full reaction of the polyurethane material A and the polyurethane material B;
S2: mixing and banburying the polyurethane material A, the flake graphite powder with a particle size of 850-1200 meshes, the premix I, and the dispersing agent for 3 min at 50° C., then adding montmorillonite, the catalyst, and the co-catalyst, and mixing and banburying for 3 min, thereby obtaining premix II;
S3: adding the polyurethane material B, the foaming agent, and crosslinking agent to the premix II, then mixing and banburying at 50° C. for 7-10 s, quickly injecting a resultant compound into a mold for foaming, curing, and molding through a nozzle of a filling machine, with a foaming temperature of 45-60° C. and a foaming time of 4-5 min, and then die cutting, thereby obtaining sheets of the polyurethane composite material.

There exists application of the phase change cooling polyurethane composites in this example in the preparation of shoe insoles, fitness mats, sports protectors, mouse pads, protective covers for cell phones or tablet computers, backpack liner pads, mattresses, seat cushions, floor mats, and apparel fabrics.

### Example 1

A preparation method of the phase-change temperature-reducing polyurethane composite material comprises steps as follows:
S1: getting materials ready according to the following parts by mass: 50 parts of polyurethane material A+polyurethane material B, 1 part of flake graphite powder with a particle size of 850 meshes, 0.8 parts of vermicular graphite with a particle size of 10 meshes, 10 parts of phase-change paraffin with a melting point of 35° C., 1 part of activated carbon, 0.5 parts of triethylenediamine as a catalyst, and 0.2 parts of hexaaminobenzene as a co-catalyst;
the polyurethane material A formed by mixing polyepoxypropane ether glycol with polyepoxypropane ether triol at a mass ratio of 1:1;
the polyurethane material B is xylylene diisocynate;
the mass ratio of the polyurethane material A to the polyurethane material B is 1:0.4;
S2: mixing the vermicular graphite with a particle size of 10 meshes, the activated carbon, and the phase-change paraffin with a melting point of 35° C. evenly at 40° C., and then cooling and molding at room temperature of 25° C., thereby obtaining premix I;
S3: mixing and banburying the polyurethane material A, the flake graphite powder with a particle size of 850 meshes, and the premix I for 3 min at 50° C., then adding the catalyst triethylenediamine and the co-catalyst hexaaminobenzene, and mixing and banburying for 3 min, thereby obtaining premix II;
S4: adding the polyurethane material B to the premix II, mixing and banburying at 50° C. for 7 s, quickly injecting a resultant compound into a mold for foaming, curing, and molding through a nozzle of a filling machine, with a foaming temperature of 45° C. and a foaming time of 4 min, and then die cutting, thereby obtaining sheets of the polyurethane composite material.

### Example 2

A preparation method of the phase-change temperature-reducing polyurethane composite material comprises steps as follows:
S1: getting materials ready according to the following parts by mass: 50 parts of polyurethane material A+polyurethane material B, 1 part of flake graphite powder with a particle size of 850 meshes, 0.8 parts of vermicular graphite with a particle size of 10 meshes, 10 parts of phase-change paraffin with a melting point of 35° C., 1 part of montmorillonite, 1 part of activated carbon, 0.5 parts of triethylenediamine as a catalyst, 0.2 parts of hexaaminobenzene as a co-catalyst, 0.2 parts of water as a foaming agent, 0.2 parts of polyacrylamide as a dispersing agent, and 0.2 parts of glycerol as a crosslinking agent;
the polyurethane material A formed by mixing polyepoxypropane ether glycol with polyepoxypropane ether triol at a mass ratio of 1:1;
the polyurethane material B is xylylene diisocynate;
the mass ratio of the polyurethane material A to the polyurethane material B is 1:0.4;
S2: mixing the vermicular graphite with a particle size of 10 meshes, the activated carbon, and the phase-change paraffin with a melting point of 35° C. evenly at 40° C., and then cooling and molding at room temperature of 25° C., thereby obtaining premix I;
S3: mixing and banburying the polyurethane material A, the flake graphite powder with a particle size of 850 meshes, the premix I, and the dispersing agent polyacrylamide for 3 min at 50° C., then adding montmorillonite, the catalyst triethylenediamine, and the co-catalyst hexaaminobenzene, and mixing and banburying for 3 min, thereby obtaining premix II;
S4: adding the polyurethane material B, the foaming agent water, the crosslinking agent glycerol to the premix II, mixing and banburying at 50° C. for 7 s, quickly injecting a resultant compound into a mold for foaming, curing, and molding through a nozzle of a filling machine, with a foaming temperature of 45° C. and a foaming time of 4 min, and then die cutting, thereby obtaining sheets of the polyurethane composite material.

### Example 3

A preparation method of the phase-change temperature-reducing polyurethane composite material comprises steps as follows:
S1: getting materials ready according to the following parts by mass: 60 parts of polyurethane material A+polyurethane material B, 1.5 parts of flake graphite powder with a particle size of 1000 meshes, 1 part of vermicular graphite with a particle size of 20 meshes, 15 parts of phase-change paraffin with a melting point of 35° C., 2 parts of montmorillonite, 2 parts of activated carbon, 1.3 parts of bis(2, dimethylaminoethyl)ether as a catalyst, 0.6 parts of hexaaminobenzene as a co-catalyst, 0.6 parts of water as a foaming agent, 0.6 parts of sodium polyacrylate as a dispersing agent, and 0.6 parts of trimethylolpropane as a crosslinking agent;
the polyurethane material A is formed by mixing polyepoxypropane ether glycol with polyepoxypropane ether triol at a mass ratio of 1:2;
the polyurethane material B is hexamethylene diisocyanate;
the mass ratio of the polyurethane material A to the polyurethane material B is 1:0.45;
S2: mixing the vermicular graphite with a particle size of 20 meshes, the activated carbon, and the phase-change paraffin with a melting point of 35° C. evenly at 40° C., and then cooling and molding at room temperature of 25° C., thereby obtaining premix I;
S3: mixing and banburying the polyurethane material A, the flake graphite powder with a particle size of 1000 meshes, the premix I, and the dispersing agent sodium polyacrylate for 3 min at 50° C., then adding montmorillonite, the catalyst bis(2, dimethylaminoethyl)ether, and the co-catalyst hexaaminobenzene, and mixing and banburying for 3 min, thereby obtaining premix II;
S4: adding the polyurethane material B, the foaming agent water, the crosslinking agent trimethylolpropane to the premix II, mixing and banburying at 50° C. for 9 s, quickly injecting a resultant compound into a mold for foaming, curing, and molding through a nozzle of a filling machine, with a foaming temperature of 45° C. and a foaming time of 4.5 min, and then die cutting, thereby obtaining sheets of the polyurethane composite material.

### Example 4

A preparation method of the phase-change temperature-reducing polyurethane composite material comprises steps as follows:
S1: getting materials ready according to the following parts by mass: 70 parts of polyurethane material A+polyurethane material B, 2 parts of flake graphite powder with a particle size of 1100 meshes, 1.5 parts of vermicular graphite with a particle size of 30 meshes, 20 parts of phase-change paraffin with a melting point of 35° C., 3 parts of montmorillonite, 3 parts of activated carbon, 2 parts of N,N-dimethylcyclohexylamine as a catalyst, 0.8 parts of hexaaminobenzene as a co-catalyst, 0.8 parts of water as a foaming agent, 0.8 parts of polyoxyethylene ether as a dispersing agent, and 0.8 parts of pentaerythritol as a crosslinking agent;
the polyurethane material A is formed by mixing polyepoxypropane ether glycol with polyepoxypropane ether triol at a mass ratio of 1:2.5;
the polyurethane material B is isophorone isocyanate;
the mass ratio of the polyurethane material A to the polyurethane material B is 1:0.5;
S2: mixing the vermicular graphite with a particle size of 30 meshes, the activated carbon, and the phase-change paraffin with a melting point of 35° C. evenly at 40° C., and then cooling and molding at room temperature of 25° C., thereby obtaining premix I;
S3: mixing and banburying the polyurethane material A, the flake graphite powder with a particle size of 1100 meshes, the premix I, and the dispersing agent polyoxyethylene ether for 3 min at 50° C., then adding montmorillonite, the catalyst N,N-dimethylcyclohexylamine, and the co-catalyst hexaaminobenzene, and mixing and banburying for 3 min, thereby obtaining premix II;
S4: adding the polyurethane material B, the foaming agent water, the crosslinking agent pentaerythritol to the premix II, mixing and banburying at 50° C. for 10 s, quickly injecting a resultant compound into a mold for foaming, curing, and molding through a nozzle of a filling machine, with a foaming temperature of 55° C. and a foaming time of 5 min, and then die cutting, thereby obtaining sheets of the polyurethane composite material.

### Example 5

A preparation method of the phase-change temperature-reducing polyurethane composite material comprises steps as follows:
S1: getting materials ready according to the following parts by mass: 80 parts of polyurethane material A+polyurethane material B, 3 parts of flake graphite powder with a particle size of 1200 meshes, 1.8 parts of vermicular graphite with a particle size of 40 meshes, 30 parts of phase-change paraffin with a melting point of 35° C., 3 parts of montmorillonite, 3 parts of activated carbon, 2 parts of N,N-dimethylcyclohexylamine as a catalyst, 1 part of hexaaminobenzene as a co-catalyst, 1 part of water as a foaming agent, 1 part of polyoxyethylene ether as a dispersing agent, and 1 part of pentaerythritol as a crosslinking agent;
the polyurethane material A is formed by mixing polyepoxypropane ether glycol with polyepoxypropane ether triol at a mass ratio of 1:3;
the polyurethane material B is isophorone isocyanate;
the mass ratio of the polyurethane material A to the polyurethane material B is 1:0.5;
S2: mixing the vermicular graphite with a particle size of 40 meshes, the activated carbon, and the phase-change paraffin with a melting point of 35° C. evenly at 40° C., and then cooling and molding at room temperature of 25° C., thereby obtaining premix I;
S3: mixing and banburying the polyurethane material A, the flake graphite powder with a particle size of 1200 meshes, the premix I, and the dispersing agent polyoxyethylene ether for 3 min at 50° C., then adding montmorillonite, the catalyst N,N-dimethylcyclohexylamine, and the co-catalyst hexaaminobenzene, and mixing and banburying for 3 min, thereby obtaining premix II;
S4: adding the polyurethane material B, the foaming agent water, the crosslinking agent pentaerythritol to the premix II, mixing and banburying at 50° C. for 10 s, quickly injecting a resultant compound into a mold for foaming, curing, and molding through a nozzle of a filling machine, with a foaming temperature of 60° C. and a foaming time of 5 min, and then die cutting, thereby obtaining sheets of the polyurethane composite material.

Contrast Example 1 is the same as Example 2, except that the co-catalyst hexaaminobenzene was not added in the operation of S3.

### Contrast Example 2

A preparation method of the phase-change temperature-reducing polyurethane composite material comprises steps as follows:
S1: the same as that in Example 2;
S2: mixing and banburying the polyurethane material A, the flake graphite powder with a particle size of 850 meshes, the vermicular graphite with a particle size of 10 meshes, the phase-change paraffin with a melting point of 35° C., the activated carbon, and the dispersing agent polyacrylamide for 3 min at 50° C., then adding montmorillonite, the catalyst triethylenediamine, and the co-catalyst hexaaminobenzene, and mixing and banburying for 3 min, thereby obtaining a premix;
S3: adding the polyurethane material B, the foaming agent water, the crosslinking agent glycerol to the premix, mixing and banburying at 50° C. for 7 s, quickly injecting a resultant compound into a mold for foaming, curing, and molding through a nozzle of a filling machine, with a foaming temperature of 45° C. and a foaming time of 4 min, and then die cutting, thereby obtaining sheets of the polyurethane composite material.

The —NCO content in the finished products of Examples 1-3 and Contrast Examples 1-2 was determined and the situations of frosting on the surface were observed. The test results are shown in the following table:

| | | Situations of Frosting on the |
|---|---|---|
| | —NCO Content/% | Surface |
| Example 1 | 5.8 | a very small amount of white |
| | | frost appeared |
| Example 2 | 3.6 | no frosting |
| Example 3 | 1.2 | no frosting |
| Example 4 | 0.4 | no frosting |
| Example 5 | 0.1 | no frosting |
| Contrast Example 1 | 21.3 | a small amount of white frost |
| | | appeared |
| Contrast Example 2 | 7.9 | a relatively large amount of |
| | | white frost appeared |

As can be seen from the above table, compared with the preparation method in Contrast Example 1, the preparation methods in Examples 1-5 can realize the full reaction of the polyurethane material A and the polyurethane material B within a very short period of time; the preparation of the sheets of the polyurethane composite material can be finished in about 10 min, which indicates that the co-catalyst hexaaminobenzen greatly improves the reaction rate; at the same time, hexaaminobenzen also helps to enhance the crosslinking density and the polymerization degree of the polyurethane composite material, restricts the movement of molecules of the phase-change paraffin, and further improves the resistance of the finished product to paraffin leakage and frosting to a certain extent; compared with that in Contrast Example 2, the polyurethane composite material made in Examples 1-5 exhibit a more excellent effect in preventing paraffin from leakage, crystallization, and frosting, which indicates that created by premixing the vermicular graphite with a particle size of 10-40 meshes, the activated carbon, and the phase-change paraffin in Examples 1-5, a composite-phase structure adsorbing paraffin fluid can significantly inhibit the infiltration and flow of the phase-change paraffin; at the same time, since the composite-phase structure restricts the activity of non-reactive monomer paraffin, it also contributes to a certain extent to the full reaction of the polyurethane material A and the polyurethane material B; moreover, the polyurethane composite material produced in Example 2 is superior to that of Example 1 in the resistance to paraffin frosting, which indicates that the employment of montmorillonite and the crosslinking agent has a certain influence on the improvement of the stability of the phase-change paraffin.

The polyurethane composite material produced in Examples 1-5 can be applied in the preparation of shoe insoles, fitness mats, sports protectors, mouse pads, protective covers for cell phones or tablet computers, backpack inner liners, mattresses, seat cushions, floor cushions, and garment fabrics. When it is used as a shoe insole or sole material, hot soles of feet can feel cool within 2-3 min; especially, more significant ice cool experience is brought to arches of the feet; upon actual measurement, the temperature inside shoes can be reduced by 1-3° C. (which varies from person to person).

It should be understood by persons skilled in the art that the discussion of any of the above examples is merely exemplary, and is not intended to imply that the scope of the present invention (including the claims) is limited to these examples; in the context of the present invention, the above examples or the technical features in different examples can also be combined with each other, and the steps can be carried out in any order; moreover, there are many other variations in different aspects of the present invention as described above; for the sake of conciseness, they are not provided in detail.

The present invention is intended to cover all substitutions, modifications, and transformations that fall within the broad scope of the appended claims. Therefore, any omissions, modifications, equivalent substitutions, improvements among others made within the spirit and principle of the present invention shall fall within the scope of protection of the present invention.

1. A phase-change temperature-reducing polyurethane composite material, comprising parts by mass of raw materials as follows: 50-80 parts of polyurethane material A+polyurethane material B, 1-3 parts of flake graphite powder with a particle size of 850-1200 meshes, 0.8-1.8 parts of vermicular graphite with a particle size of 10-40 meshes, 10-30 parts of phase-change paraffin, 1-3 parts of activated carbon, 0.5-2 parts of catalyst, and 0.2-1 parts of co-catalyst.

2. The phase-change temperature-reducing polyurethane composite material of claim 1, comprising parts by mass of raw materials as follows: 50-80 parts of polyurethane material A+polyurethane material B, 1-3 parts of flake graphite powder with a particle size of 850-1200 meshes, 0.8-1.8 parts of vermicular graphite with a particle size of 10-40 meshes, 10-30 parts of phase-change paraffin, 1-3 parts of montmorillonite, 1-3 parts of activated carbon, 0.5-2 parts of catalyst, 0.2-1 parts of co-catalyst, 0.2-1 parts of foaming agent, 0.2-1 parts of dispersing agent, and 0.2-1 parts of crosslinking agent.

3. The phase-change temperature-reducing polyurethane composite material of claim 1, wherein the polyurethane material A is formed by mixing polyepoxypropane ether glycol with polyepoxypropane ether triol at a mass ratio of 1:(1-3).

4. The phase-change temperature-reducing polyurethane composite material of claim 1, wherein the polyurethane material B is one or more of xylylene diisocynate, hexamethylene diisocyanate, and isophorone isocyanate.

5. The phase-change temperature-reducing polyurethane composite material of claim 4, wherein mass ratio of the polyurethane material A to the polyurethane material B is 1:(0.4-0.5).

6. The phase-change temperature-reducing polyurethane composite material of claim 1, wherein the catalyst is one or more of triethylenediamine, bis(2, dimethylaminoethyl)ether, and N,N-dimethylcyclohexylamine.

7. The phase-change temperature-reducing polyurethane composite material of claim 1, wherein the phase-change paraffin has a melting point of 35° C.; the co-catalyst is hexaaminobenzen; and the foaming agent is water.

8. The phase-change temperature-reducing polyurethane composite material of claim 1, wherein the dispersing agent is one or more of polyacrylamide, sodium polyacrylate, and polyoxyethylene ether.

9. The phase-change temperature-reducing polyurethane composite material of claim 1, wherein the crosslinking agent is one or more of glycerol, trimethylolpropane, triethanolamine, and pentaerythritol.

10. A preparation method of a phase-change temperature-reducing polyurethane composite material, comprising steps as follows:
S1: mixing the vermicular graphite with a particle size of 10-40 meshes, the activated carbon, and the phase-change paraffin evenly at 40° C., then cooling and molding at room temperature of 25° C., thereby obtaining premix I;
S2: mixing and banburying the polyurethane material A, the flake graphite powder with a particle size of 850-1200 meshes, the premix I, and the dispersing agent for 3 min at 50° C., then adding montmorillonite, the catalyst, and the co-catalyst, and mixing and banburying for 3 min, thereby obtaining premix II;
S3: adding the polyurethane material B, the foaming agent, and crosslinking agent to the premix II, then mixing and banburying at 50° C. for 7-10 s, quickly injecting a resultant compound into a mold for foaming, curing, and molding through a nozzle of a filling machine, with a foaming temperature of 45-60° C. and a foaming time of 4-5 min, and then die cutting, thereby obtaining sheets of the polyurethane composite material.

11. (canceled)
